(19) United States
(12) Patent Application Publication
(10) Pub. No.: US 2026/0237019 A1
(43) Pub. Date: Aug. 13, 2026

(54) SUBJECT-DRIVEN DIFFUSION NEURAL NETWORKS

(71) Applicant: Google LLC, Mountain View, CA (US)

(72) Inventors: Wenhu Chen, Waterloo (CA); Hexiang Hu, Redmond, WA (US); Ming-Wei Chang, Redmond, WA (US); William W. Cohen, Pittsburgh, PA (US)

(21) Appl. No.: 19/471,034

(22) PCT Filed: Mar. 29, 2024
(86) PCT No.: PCT/US2024/022364

§ 371 Date: Sep. 30, 2025

Related U.S. Application Data
(60) Provisional application No. 63/456,411, filed on Mar. 31, 2023.

(51) Int. Cl. G06T 3/4046; G06N 3/045; G06V 10/82

(52) U.S. Cl. CPC G06T 3/4046; G06N 3/045; G06V 10/82

(57) ABSTRACT

Methods, systems, and apparatus, including computer programs encoded on computer storage media, for generating images of a new subject using a diffusion neural network.

### CROSS-REFERENCE TO RELATED APPLICATION

This application claims priority to U.S. Provisional Application No. 63/456,411, filed on Mar. 31, 2023. The disclosure of the prior application is considered part of and is incorporated by reference in the disclosure of this application.

### BACKGROUND

This specification relates to generating images using neural networks.

Neural networks are machine learning models that employ one or more layers of nonlinear units to predict an output for a received input. Some neural networks include one or more hidden layers in addition to an output layer. The output of each hidden layer is used as input to or more other layers in the network, i.e., one or more other hidden layers, the output layer, or both. Each layer of the network generates an output from a received input in accordance with current values of a respective set of parameters.

### SUMMARY

This specification describes a system implemented as computer programs on one or more computers that generates images conditioned on text descriptions using a diffusion neural network.

In particular, the system uses the diffusion neural network to perform subject-driven image generation, i.e., to generate images that are about a subject that is specified in an input to the system.

A “subject,” as used in this specification, is a characteristic of a scene that is depicted in an image.

For example, a subject can be a specific object that is depicted in the scene, i.e., a specific animal, a specific person, or a specific other, inanimate object. Examples of specific objects can include specific dogs, shoes, backpacks, and so on.

Particular embodiments of the subject matter described in this specification can be implemented so as to realize one or more of the following advantages.

Recent text-to-image generation models have shown great progress in generating highly realistic, accurate, and diverse images from a given text prompt. Though achieving unprecedented success in generating highly accurate images, these models are not able to customize to a given subject, like a specific dog, shoe, backpack, etc.

Therefore, some approaches attempt to perform subject-driven text-to-image generation, the task of generating highly customized images with respect to a target subject.

Subject-driven image generation is related to text-driven image editing but often needs to perform more sophisticated transformations to source images (e.g., rotating the view, zooming in/out, changing the pose of subject, etc.) when generating a new image in order to align with a text description of the desired contents of the new image. As a result, existing image editing methods, i.e., those not specifically tailored for subject-driven generation, are generally not suitable for this new task.

Moreover, existing subject-driven text-to-image generation approaches are slow and expensive. In particular, existing approaches require fine-tuning specific models for a given subject on one or a few demonstrated examples. This further training typically requires significant additional time, e.g., at least 10-20 minutes, and computational resources, e.g., processor cycles and hardware accelerator usage, due to the need to specialize the text-to-image model checkpoint for the given subjects. In particular, these approaches are time-consuming as they require back-propagating gradients over the entire model for hundreds or even thousands of steps per customization. Moreover, they are space-consuming as they require storing a subject-specific checkpoint per subject. That is, existing approaches require storing a separate fine-tuned model for each subject, which is very memory-intensive.

To avoid excessive computation and memory costs while still performing high-accurate generation, this specification describes a single subject-driven text-to-image generation model that can perform on-the-fly subject customization. That is, by taking demonstration pairs as input at inference time (in addition to a new text description), a single diffusion neural network can be used to generate new images of many different specific subjects.

In particular, the model can instantly adapt to unseen subjects and unseen or even compositional descriptions with only 3-5 in-context demonstrations with minimal latency, e.g., within 30 seconds (on a Cloud TPU v4), and with no additional optimization.

For example, the model can be trained with a novel apprenticeship learning algorithm, described in this specific, that uses the model to imitate the behaviors of a large number of specialized expert models, allowing the model to perform well at generalizing to new subjects after training give only a few in-context demonstration pairs of the new subject.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example neural network system.

FIG. 2 shows an example of the operation of the system after training.

FIG. 3 is a flow diagram of an example process for generating a new image of a new subject.

FIG. 4 is a flow diagram of an example process for using the diffusion neural network to generate a new image of a new subject.

FIG. 5 is a flow diagram of an example process for training the diffusion neural network.

FIG. 6 shows an example of performing apprenticeship learning to generate training data for training the diffusion neural network.

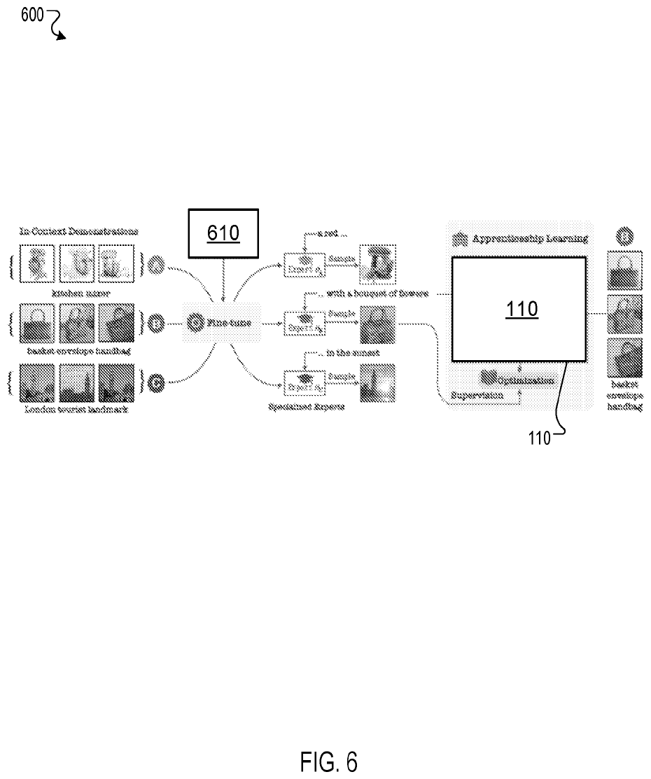

Like reference numbers and designations in the various drawings indicate like elements.

### DETAILED DESCRIPTION

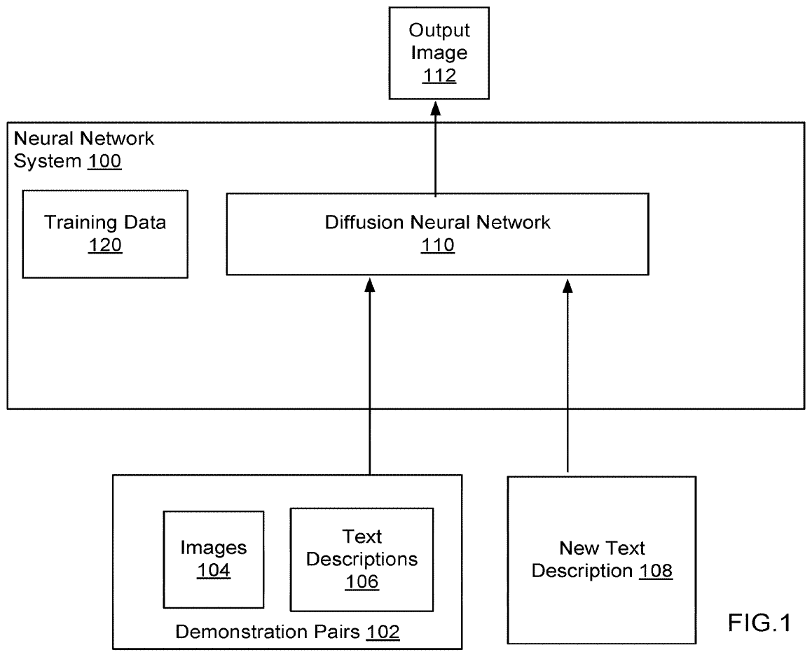

FIG. 1 is a diagram of an example neural network system 100. The neural network system 100 is an example of a system implemented as computer programs on one or more computers in one or more locations, in which the systems, components, and techniques described below can be implemented.

The system 100 is a system that uses a diffusion neural network 110 to perform subject-driven image generation, i.e., to generate images 112 that are about a subject that is specified in an input to the system 100.

A “subject,” as used in this specification, is a characteristic of a scene that is depicted in an image.

For example, a subject can be a specific object that is depicted in the scene, i.e., a specific animal, a specific person, or a specific other, inanimate object. Examples of specific objects can include specific dogs, shoes, backpacks, and so on.

Thus, subject-driven image generation requires, given a text description corresponding to a given subject, generating an image of the given subject in a scene that is described by the text description.

In particular, after training, the system 100 can generate new images of new subjects that were not seen in training data 120 for the diffusion neural network 110.

To perform subject-driven image generation for a new subject, the system 100 receives a plurality of demonstration pairs 102 for the new subject.

Each demonstration pair 102 includes (i) an image 104 relating to the new subject, e.g., an image that depicts a scene that includes the new subject, and (ii) a text description 106 of the image 104 in the demonstration pair 102.

In some implementations, the system 100 receives both the images 104 and the corresponding text descriptions 106 from a user of the system 100.

In some other implementations, the system 100 receives the images 104 from a user of the system 100 and then generates the corresponding text description for each image 104 by processing the image 104 using a trained image captioning neural network.

The system 100 also receives a new text description 108 relating to the new subject. For example, the system 100 can receive the new text description 108 from the same user as the demonstration pairs 102 or from a different user. The new text description 108 generally describes a scene in which the new subject should be depicted in a new image.

The system 100 then processes the demonstration pairs 102 and the new text description 108 using the diffusion neural network 110 to generate a new image 112 that is described by the new text description 108.

Prior to using the diffusion neural network 110 to generate new images 112, the system 100 or another training system trains the diffusion neural network 110 on the training data 120.

In particular, after being trained, the diffusion neural network 110 can effectively generate new images 112 of new subjects conditioned only on a small number, e.g., between two and ten, of demonstration pairs 102 of the subject and without being fine-tuned or further trained on any of the demonstration images of the new subject.

The diffusion neural network 110 can generally be any appropriate conditional diffusion neural network.

In particular, the diffusion neural network 110 is configured to receive a diffusion input that includes an input image and a conditioning input for a target image and to process the input to generate a diffusion output for the initial image. Generally, the diffusion input also includes a timestep that defines a noise level for the input image. The conditioning input generally represents the demonstration pairs and the new text description.

In some implementations, the diffusion neural network 110 performs a diffusion process in pixel space, so that the images operated on and generated by the diffusion neural network have values for each pixel that specify color values, e.g., RGB values or another color encoding scheme. In these examples, the diffusion output can be an estimate of the target image or an estimate of the noise that has been added to the target image to arrive at the input image.

In some other implementations, the diffusion neural network 110 performs a diffusion process in latent space, e.g., in a latent space that is lower-dimensional than the pixel space. That is, the images operated on by the diffusion neural network 110 are latent images and the values for the pixels of the images are learned, latent values rather than color values. In these examples, the diffusion output can be an estimate of a latent representation of the target image or an estimate of the noise that has been added to the latent representation of the target image in the latent space to arrive at the input latent representation in the latent space.

In these implementations, the trained diffusion neural network 110 can be associated with an image encoder to encode images into the latent space and a decoder neural network that receives an input that includes a latent representation of an image and decodes the latent representation to reconstruct the image. For example, the encoder and decoder can have been trained jointly on an image reconstruction objective, e.g., a VAE objective, a VQ-GAN objective, or a VQ-VAE objective.

Thus, in these examples, after training, the system 100 can use the decoder neural network to generate the output image 112 from the image in the latent space that has been generated using the diffusion neural network 110.

The diffusion neural network 110 can generally have any appropriate neural network architecture.

For example, the diffusion neural network 110 can be a convolutional neural network, e.g., a U-Net, that has multiple convolutional layer blocks. In some of these cases, the diffusion neural network 110 can include one or more cross-attention layer blocks interspersed among the convolutional layer blocks. As will be described below, some or all of the cross-attention blocks can be conditioned on a representation of the conditioning input.

As another example, the diffusion neural network 110 can be a Transformer neural network that processes the diffusion input through a set of self-attention layers to generate the diffusion output. In these examples, the neural network can also include one or more attention blocks that are conditioned on a representation of the conditioning input.

In particular, the diffusion neural network 110 can include a text encoder neural network that generates an encoded representation of the text sequences included in the conditioning input and an image encoder neural network that generates an encoded representation of the images in the demonstration pairs 102.

One or more of the layers of the diffusion neural network 110, e.g., one or more cross-attention layers or one or more self-attention layers, can then be conditioned on one or both of the encoded representations of the text descriptions and the demonstration images 104.

One example of the architecture of the diffusion neural network 110 will be described in more detail below.

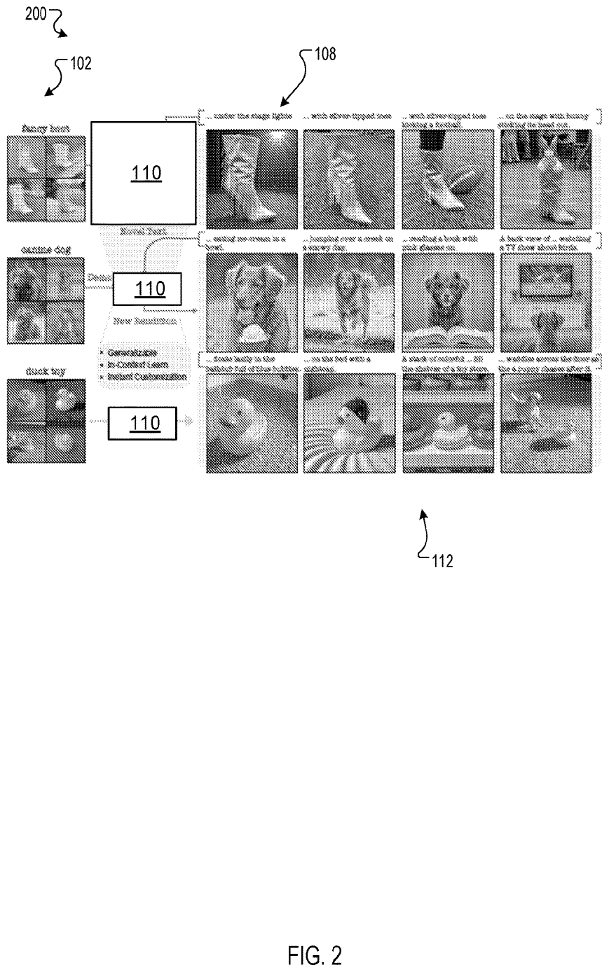

FIG. 2 shows an example 200 of the operation of the system 100 after training.

In particular, FIG. 2 shows three sets of demonstration pairs 102 for three different subjects (a “fancy boot,” a “canine dog,” and a “duck toy”).

For each subject, the system 100 receives four new text descriptions 108 and, for each new text description 108 and from the new text description 108 and the demonstration pairs 102 for the subject, generates a respective new image 112 of the subject in the context described by the new text description using the diffusion neural network 110 without performing any further training of the diffusion neural network 110 using any of the images or the text in the demonstration pairs 102 for the subject.

Thus, as can be seen from FIG. 2, the system 100 can generate new images 112 of specific subjects given only a small number of demonstration pairs 102 and without any further training or optimization of the diffusion neural network 110.

In particular, as shown in FIG. 2, the new images 112 are new renditions of the given subject and generated by a diffusion neural network 110 that has been trained to be generalizable, i.e., to generalize to new subjects after training, that can in-context learn, i.e., that receives the demonstration pairs 102 at inference time and extracts context from those demonstration pairs 102 without further training, and that provides instant customization by virtue of being able to generate new images of new subjects without requiring additional training.

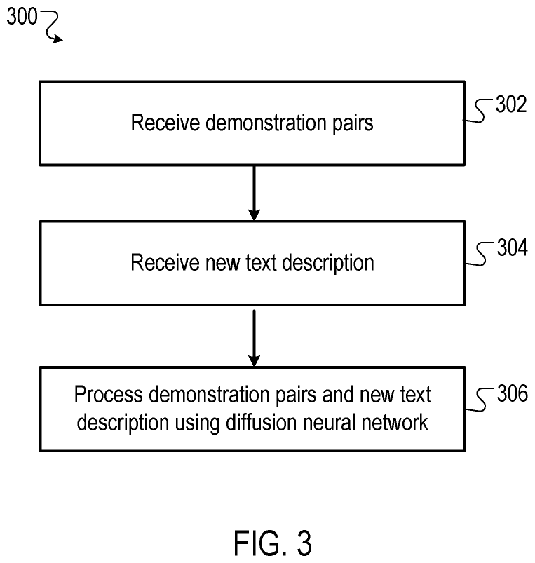

FIG. 3 is a flow diagram of an example process 300 for generating a new image of a new subject. For convenience, the process 300 will be described as being performed by a system of one or more computers located in one or more locations. For example, a training system, e.g., the neural network system 100 depicted in FIG. 1, appropriately programmed in accordance with this specification, can perform the process 300.

The system receives a plurality of demonstration pairs (step 302).

Each demonstration pair includes (i) an image relating to an input subject and (ii) a text description of the image in the demonstration pair.

The system receives a new text description relating to the input subject (step 304). For example, the new text description can describe a new context in which the input subject is to be depicted.

The system processes the demonstration pairs and the new text description using a diffusion neural network to generate a new image that is described by the new text description (step 306).

In particular, the system generates the new image across multiple reverse diffusion steps.

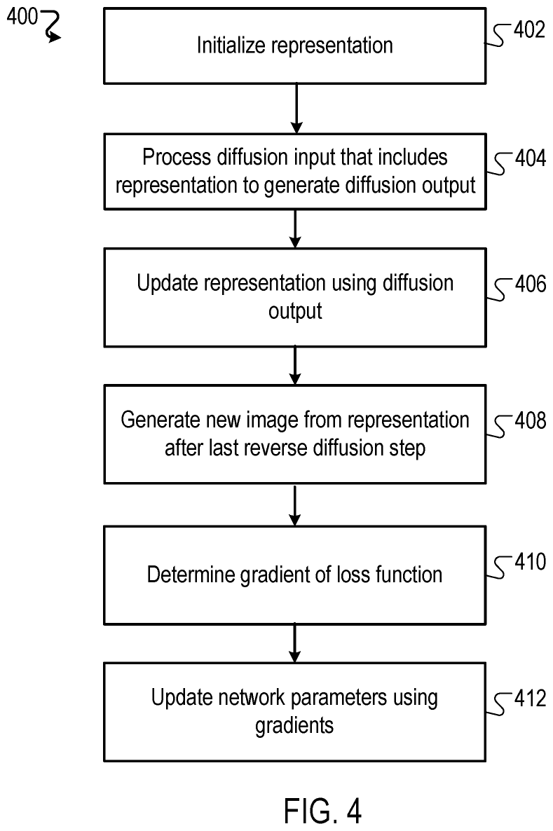

Generating the new image using the diffusion neural network is described below with reference to FIG. 4.

In some implementations, the diffusion neural network generates an output image that is lower-resolution image than a required resolution for the new image.

In these implementations, the system can generate the new image from the representation of the new image after the last reverse diffusion step by processing the representation through one or more super-resolution neural networks. As a particular example, each super-resolution neural network can be a respective different diffusion neural network that is also conditioned on the new text description (but not on the demonstration pairs).

FIG. 4 is a flow diagram of an example process 400 for using the diffusion neural network to generate a new image of a new subject. For convenience, the process 400 will be described as being performed by a system of one or more computers located in one or more locations. For example, a training system, e.g., the neural network system 100 depicted in FIG. 1, appropriately programmed in accordance with this specification, can perform the process 400.

The system initializes a representation of the new image (step 402). For example, the system can sample each value in the representation from a specified noise distribution, e.g., a Gaussian distribution or other appropriate distribution.

The system then updates the representation of the new image at each of a plurality of reverse diffusion steps. At each reverse diffusion step, the system performs steps 404 and 406 to update the representation.

In particular, at each reverse diffusion step, the system processes a diffusion input for the reverse diffusion step that includes the representation of the new image using the diffusion neural network conditioned on (i) the text description of the new image and (ii) the demonstration pairs to generate a diffusion output (step 404).

In particular, the diffusion neural network includes one or more layers that are conditioned on a representation of the text description, a representation of the demonstration pairs or both.

For example, the diffusion neural network can include one or more attention layers that each cross-attend over a respective representation of at least a portion of the text descriptions, images, or both in the demonstration pairs.

As a particular example, the diffusion neural network can include a first attention layer that cross-attends over a respective representation of each of the text descriptions in the demonstration pairs and a second attention layer that cross-attends over a respective representation of each of the images in the demonstration pairs.

As a specific example, the diffusion neural network can include a diffusion encoder that takes an image, text, and a time step as an input and that generates as output a feature map. The feature map can have the same spatial resolution as the input image or a different spatial resolution, e.g., downsampled spatial resolution relative to the input image. For example, the diffusion encoder can include a set of convolutional layers that process the image and one or more attention layers, e.g., self-attention layers or cross-attention layers, that each update a representation of the image using a representation of the text, a representation of the time step, or both.

The diffusion neural network can also include a diffusion decoder that processes a feature map to generate the diffusion output. For example, the diffusion decoder can include a set of convolutional layers. Optionally, the diffusion decoder can also include one or more attention layers, e.g., self-attention layers or cross-attention layers, that each update a representation of the image using a representation of the text, a representation of the time step, or both.

In this specific example, the system can process each demonstration pair using the diffusion encoder (with the time step set to a default value, e.g., zero) to generate a respective feature map for each demonstration pair.

At each reverse diffusion step, the diffusion neural network can then process the representation of the new image, the new text description, and a time step corresponding to the reverse diffusion step using the diffusion encoder to generate a feature map for the representation of the new image.

The diffusion neural network can then apply an attention module, e.g., a multi-head self-attention module or cross-attention module, to the feature map of the representation and the feature maps for the demonstration pairs to generate an updated feature map. The diffusion neural network can then process the updated feature map using the diffusion decoder to generate the diffusion output for the reverse diffusion step.

The system then updates the representation using the diffusion output (step 406).

For example, the system can determine an estimate of a final representation, i.e., un-noised representation, from the diffusion output and then apply an appropriate diffusion sampler, e.g., the DDPM (Denoising Diffusion Probabilistic Model) sampler, the DDIM (Denoising Diffusion Implicit Model) sampler or another appropriate sampler, to the estimate to generate an updated representation.

Optionally, after the last reverse diffusion iteration, the system can refrain from using the diffusion sampler and can instead use the estimate as the updated representation.

To determine the estimate, the system can use the diffusion output as the final diffusion output.

Alternatively, the system can make use of classifier-free guidance. In these cases, the system can process another diffusion input for the reverse diffusion step that includes the representation of the new image using the diffusion neural network to generate another diffusion output. When generating the other diffusion output, the system can refrain from conditioning the diffusion neural network on the text description and the demonstration images.

The system can then combine the diffusion output and the other diffusion output in accordance with a guidance weight to generate the final diffusion output. That is, the system can determine a weighted sum of (or weighted difference between) the diffusion output and the other diffusion output, with the weights being determined by the guidance weight.

When the diffusion output is an estimate of the new image, the system can directly use the final diffusion output as the estimate. When the diffusion output is an estimate of noise, the system can determine the estimate \hat{x}₀ from the current representation xₜ, the diffusion output ϵ_{θ}, and a noise level α̅ₜ that corresponds to the reverse diffusion step (and is defined by the time step t):

$${\hat{x}}_{0} = ( {x}_{t} - \sqrt{1 - {\overline{a}}_{t}} {ϵ}_{θ} ) / \sqrt{{\overline{a}}_{t}} .$$

After performing the last reverse diffusion step, the system generates the new image from the representation of the new image after the last reverse diffusion step (step 408).

In some cases, the system uses the representation of the new image after the last reverse diffusion step as the new image.

In some other cases, the system performs further processing on the representation to generate the new image.

For example, the representation can be a low-resolution version of the new image. In this example, the system can generate the new image from the representation of the new image after the last reverse diffusion step by processing the representation through one or more super-resolution neural networks. As a particular example, each super-resolution neural network can be a respective different diffusion neural network that is also conditioned on the new text description.

As another example, when the representation is in the latent space, the system can use the decoder described above to map the representation from the latent space to the pixel space.

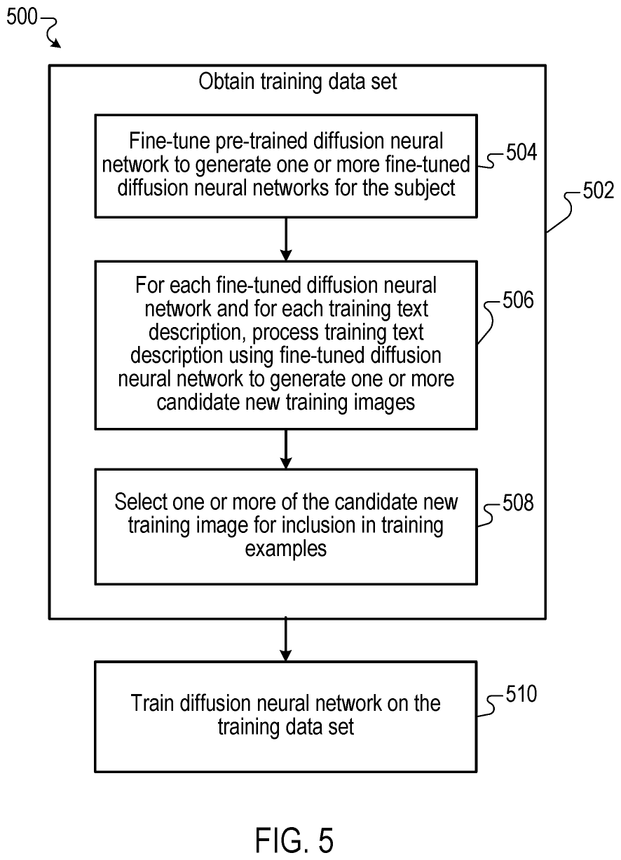

FIG. 5 is a flow diagram of an example process 500 for training the diffusion neural network. For convenience, the process 500 will be described as being performed by a system of one or more computers located in one or more locations. For example, a training system, e.g., the neural network system 100 depicted in FIG. 1, appropriately programmed in accordance with this specification, can perform the process 500.

The system obtains a training data set for training the diffusion neural network (step 502).

The training data set includes, for each of a plurality of multiple subjects, one or more training examples.

Generally, each training example for a given subject includes (i) a set of training demonstration pairs, (ii) a training text description relating to the subject, and (iii) a training new image that is described by the training text description.

As described above, the training demonstration pairs for a given subject each include (i) an image relating to the subject and (ii) a text description of the image in the training demonstration pair.

The system can generally obtain the training data set in any of a variety of ways.

As one example, the system can make use of apprenticeship learning in order to generate some or all of the training examples in the training data set.

In particular, when making use of apprenticeship learning, the system generates training data using one or more fine-tuned diffusion neural networks that have each been fine-tuned starting from a pre-trained diffusion neural network.

The pre-trained diffusion neural network can be any appropriate pre-trained, text-conditional diffusion neural network. Examples of such diffusion neural networks include Imagen, Stable Diffusion, and so on.

As one example, to make use of apprenticeship learning for a given one of the subjects, the system can perform steps 504-508.

The system fine-tunes the pre-trained diffusion neural network on training data that includes the demonstration pairs for the given subject to generate one or more fine-tuned diffusion neural networks for the subject (step 504).

To fine-tune the pre-trained diffusion neural network on training data that includes the demonstration pairs for the given subject, the system can train the pre-trained diffusion neural network on the training data using a denoising objective, e.g., the time re-weighted squared error loss described below. Unlike the diffusion neural network 110, the fine-tuned diffusion neural networks do not receive the demonstration pairs at inference time and are only conditioned on a text description at inference time.

For each fine-tuned diffusion neural network for the given subject and for each training text description for the subject, the system can process the training text description for the subject using the fine-tuned diffusion neural network to generate one or more candidate new training images (step 506). That is, because generation of a new image starts with initializing a representation using sampled noise, by sampling different initial representations from the same distribution, the system can cause a given diffusion neural network to generate a different output image.

The system can then select one or more of the candidate new training images for inclusion in respective ones of the training examples for the subject (step 508).

For example, for each of the candidate new training images, the system can determine a quality score for the candidate new training image that measures how well the new training image is described by the corresponding training text description.

To generate a quality score for a given new training image, the system can process the candidate new training image using an image encoder neural network to generate an image embedding of the image.

The system can then process the training text description using a text encoder neural network to generate a text embedding of the image.

The system can then determine the quality score based on a similarity between the text embedding and the image embedding. The similarity can be, e.g., the dot product or cosine similarity between the text embedding and the image embedding.

For example, the image and text encoders can have been jointly trained, e.g., through contrastive learning or through another unsupervised learning technique, so that text embeddings and image embeddings are close to one another in the embedding space when the corresponding text describes the contents of the corresponding image.

The system can then select one or more of the candidate new training images based on the quality scores.

For example, the system can select each candidate new training image that satisfies a threshold.

As another example, the system can compute, for each candidate new training image, a delta quality score that is a difference between (i) the quality score for the candidate new training image and (ii) the highest quality score from among quality scores for image embeddings of the demonstration images in the corresponding set of demonstration pairs and the text embedding of the new text embedding. The system can then select any candidate new training image having a quality score that satisfies a threshold, e.g., is greater than the threshold, for inclusion in the training data set. Thus, in these cases, the system leverages the demonstration images to ascertain the quality of any given candidate new image.

The system trains the diffusion neural network on the training data set (step 510).

In particular, the system trains the diffusion neural network on an objective that measures, for each training example, a performance of the diffusion neural network in de-noising a noisy image generated from the training new image in the training example while the diffusion neural network is conditioned on the training text description in the training example and the training demonstration pairs in the training example.

For example, the objective can be a time re-weighted squared error loss or another appropriate diffusion model training loss. As one example, the loss can be represented as follows:

$${E}_{t , ϵ} {w}_{t} {‖ {x}_{0} - {\hat{x}}_{θ} ( {x}_{t} , c ) ‖}^{2} ,$$

where ϵ is sampled noise, c is a conditioning input that includes the demonstration pairs and the new text description, t is a time step, xₜ is a noisy image that has been generated from a training new image x₀ as follows: xₜ=\sqrt{α̅ₜ}x₀+\sqrt{1−α̅ₜ}ϵ, where α̅ₜ is a noise level that depends on the sampled time step t, \hat{x}_{θ}(xₜ, c) is the estimate of the training new image (either the diffusion output or an estimate generated from the diffusion output as described above). In particular, the noise level is a decreasing function of the sampled time step t, so that the larger t is the noisier xₜ will be. In some cases, the weight wₜ can be set to 1.

As a result of being trained on the objective, after training, the diffusion neural network can effectively be used to generate new images of new subjects given a small set of demonstration images without any further training.

In particular, the example 600 shows how pre-trained diffusion neural network 610 can be fine-tuned to generate a respective fine-tuned neural network (“expert”) for each of three subjects: subject A (kitchen mixer), subject B (basket envelope handbag), and subject C (London tourist landmark).

After fine-tuning, each expert can be used to sample a new image of the corresponding subject given a new text description (e.g., “a red . . . ” kitchen mixer, a basket envelope handbag “ . . . with a bouquet of flowers,” London tourist landmark “ . . . in the sunset,” and so on).

The sampled images (and the corresponding demonstrations) can then be used as supervision during the training of the diffusion neural network 110. For example, as shown in the example 600, the diffusion neural network 110 is being trained on a training example for subject B that includes the demonstration pair for subject B, the “ . . . with a bouquet of flower” text description of the sampled image for subject B, and the sampled image of subject B.

The system can generate the text descriptions for use in sampling new images of a given subject in any of a variety of ways.

For example, for each subject, the system can generate the training text description in each training example for the subject using a text generation neural network conditioned on one or more of the text descriptions in the training demonstration pairs in the training examples for the subject. As a particular example, the text generation neural network can be a large language model, e.g., the PaLM model, the PaLM 2 model, or any other appropriate decoder-only Transformer language model.

The system can perform the training of the fine-tuned neural networks and the sampling of the images from the fine-tuned neural networks in any of a variety of ways.

As one example, the system can perform the training across a plurality of training iterations.

As one example of performing the training across a plurality of training iterations, at each training iteration, the system can sample a batch that includes a plurality of sets of training demonstration pairs, with each set corresponding to a respective subject. For each set of training demonstration pairs, the system can fine-tune the pre-trained diffusion neural network on the set of training demonstration pairs to generate a fine-tuned diffusion neural network for the corresponding subject. Thus, in this example, the system trains a separate fine-tuned diffusion neural network for each corresponding subject at each training iteration.

Once the fine-tuned diffusion neural network for a given subject has been generated, the system can process a training text description for the corresponding subject using the fine-tuned diffusion neural network for the corresponding subject to generate one or more candidate new training images for the corresponding subject.

In some of these implementations, the system can leverage parallelization to decrease the latency of performing a given training iteration. For example, at each training iteration, each set of training demonstrations can be assigned to a different hardware accelerator, e.g., to a different TPU, GPU, or other ASIC, and the fine-tuning and the processing of the training text description for the sets of training demonstration pairs can be performed in parallel for each of the training demonstrations by the assigned hardware accelerators.

In some cases, the system can interleave the training of the diffusion neural network with the generation of the fine-tuned neural networks. That is, after a given training iteration to generate a given set of fine-tuned neural networks is complete, the system can use the results of the training iteration to perform a training step of training the diffusion neural network using the training data that resulted from the generation of the fine-tuned neural networks. Optionally, the system can then discard the fine-tuned neural networks and the images sampled using the fine-tuned neural networks, reducing the memory requirements of the apprenticeship learning process.

As another example of performing the training across a plurality of training iterations, at each training iteration, the system can sample a batch that includes a plurality of sets of training demonstration pairs, with each set corresponding to a respective subject. The system can then fine-tune a pre-trained diffusion neural network on the batch of training demonstration pairs to generate a fine-tuned diffusion neural network that corresponds to all of respective subjects for the sets of training demonstration pairs. Thus, in this example, the system trains a single fine-tuned diffusion neural network that corresponds to each corresponding subject (in the batch) at each training iteration.

Once the fine-tuned diffusion neural network for the subjects in the batch has been generated, the system can process a training text description for the a given one of the subjects using the fine-tuned diffusion neural network to generate one or more candidate new training images for the corresponding subject.

In some of these implementations, the system can leverage parallelization to decrease the latency of performing a given training iteration. For example, at each training iteration, the system can distribute the training and the sampling across multiple different hardware accelerators, e.g., TPUs, GPUs, or other ASICs.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, e.g., inference, workloads.

Machine learning models can be implemented and deployed using a machine learning framework, .e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers, the method comprising:
receiving a plurality of demonstration pairs, each demonstration pair comprising (i) an image relating to an input subject and (ii) a text description of the image in the demonstration pair;
receiving a new text description relating to the input subject; and
processing the demonstration pairs and the new text description using a diffusion neural network to generate a new image that is described by the new text description.

2. The method of claim 1, wherein processing the demonstration pairs and the new text description using a diffusion neural network to generate a new image that is described by the new text description comprises:
initializing a representation of the new image; and
updating the representation of the new image at each of a plurality of reverse diffusion steps, the updating comprising, at each reverse diffusion step:
processing a diffusion input for the iteration that comprises the representation of the new image using the diffusion neural network conditioned on (i) the text description of the image and (ii) the demonstration pairs to generate a diffusion output; and
updating the representation using the diffusion output.

3. The method of claim 2, wherein the diffusion neural network comprises one or more attention layers that each cross-attend over a respective representation of at least a portion of the text descriptions, images, or both in the demonstration pairs.

4. The method of claim 3, wherein the diffusion neural network comprises a first attention layer that cross-attends over a respective representation of each of the text descriptions in the demonstration pairs.

5. The method of claim 3, wherein the diffusion neural network comprises a second attention layer that cross-attends over a respective representation of each of the images in the demonstration pairs.

6. The method of claim 2, wherein processing the demonstration pairs and the new text description using a diffusion neural network to generate a new image that is described by the new text description further comprises:
generating the new image from the representation of the new image after the last reverse diffusion step.

7. The method of claim 6, wherein the representation is a low-resolution version of the new image, and wherein generating the new image from the representation of the new image after the last reverse diffusion step comprises processing the representation through one or more super-resolution neural networks.

8. The method of claim 7, wherein each super-resolution neural network is a respective different diffusion neural network that is also conditioned on the new text description.

9. A method for training a diffusion neural network that is used to process one or more demonstration pairs and a new text description to generate a new image that is described by the new text description, the method comprising:
obtaining a training data set, the training data set comprising, for each of a plurality of subjects, one or more training examples, wherein:
the training examples for each subject each comprise a plurality of training demonstration pairs, a training text description relating to the subject, and a training new image that is described by the training text description, and
the plurality of training demonstration pairs each comprise (i) an image relating to the subject and (ii) a text description of the image in the training demonstration pair; and
training the diffusion neural network on the training data set on an objective that measures, for each training example, a performance of the diffusion neural network in de-noising a noisy image generated from the training new image in the training example while the diffusion neural network is conditioned on the training text description in the training example and the training demonstration pairs in the training example.

10. The method of claim 9, wherein the objective is a time re-weighted squared error loss.

11. The method of claim 9, wherein obtaining the training data set comprises:
for each subject:
fine-tuning a pre-trained diffusion neural network on training data comprising the demonstration pairs to generate one or more fine-tuned diffusion neural networks for the subject;
for each fine-tuned diffusion neural network for the subject and for each training text description for the subject, processing the training text description for the subject using the fine-tuned diffusion neural network to generate one or more candidate new training images; and
selecting one or more of the candidate new training images for inclusion in respective ones of the training examples for the subject.

12. The method of claim 11, wherein selecting one or more of the candidate new training images for inclusion in respective ones of the training examples for the subject comprises:
for each of the candidate new training images, determining a quality score for the candidate new training image that measures how well the new training image is described by the training text description; and
selecting one or more of the candidate new training images based on the quality scores.

13. The method of claim 12, wherein determining a quality score for the candidate new training image that measures how well the new training image is described by the training text description comprises:
processing the candidate new training image using an image encoder neural network to generate an image embedding of the image;
processing the training text description using a text encoder neural network to generate a text embedding of the image; and
determining the quality score based on a similarity between the text embedding and the image embedding.

14. The method of claim 13, wherein the similarity is a dot product or a cosine similarity.

15. The method of claim 9, further comprising:
for each subject, generating the training text description in each training example for the subject using a text generation neural network conditioned on one or more of the text descriptions in the training demonstration pairs in the training examples for the subject.

16. The method of claim 15, wherein the text generation neural network is a large language model.

17. The method of claim 11, wherein generating the one or more fine-tuned neural networks for each of the subjects comprises:
at each of a plurality of training iterations:
sampling a batch comprising a plurality of sets of training demonstration pairs, wherein each set corresponds to a respective subject; and
for each set of training demonstration pairs, fine-tuning the pre-trained diffusion neural network on the set of training demonstration pairs to generate a fine-tuned diffusion neural network for the corresponding subject.

18. The method of claim 17, wherein for each fine-tuned diffusion neural network for the subject and for each training text description for the subject, processing the training text description for the subject using the fine-tuned diffusion neural network to generate one or more candidate new training images comprises:
at each of the training iterations and for each set of training demonstration pairs in the batch for the training iteration, processing a training text description for the corresponding subject using the fine-tuned diffusion neural network for the corresponding subject to generate one or more candidate new training images for the corresponding subject.

19. The method of claim 18, wherein, at each training iteration, each set of training demonstrations is assigned to a different hardware accelerator and the fine-tuning and the processing of the training text description for the sets of training demonstration pairs are performed in parallel for each of the training demonstrations by the assigned hardware accelerators.

20. A system comprising:
one or more computers; and
one or more storage devices storing instructions that, when executed by the one or more computers, cause the one or more computers to perform operations comprising:
receiving a plurality of demonstration pairs, each demonstration pair comprising (i) an image relating to an input subject and (ii) a text description of the image in the demonstration pair;
receiving a new text description relating to the input subject; and
processing the demonstration pairs and the new text description using a diffusion neural network to generate a new image that is described by the new text description.

21. (canceled)
